(19) United States
(12) Patent Application Publication
(10) Pub. No.: US 2026/0301590 A1
(43) Pub. Date: Oct. 1, 2026

(54) Method for tracking aircraft, associated computer program and set of servers

(71) Applicant: THALES, Meudon (FR)

(72) Inventors: Nicolas HONORE, RUNGIS (FR); Sander JULIEN-SAINT AMAND, RUNGIS (FR); Marc FRAGU, RUNGIS (FR)

(21) Appl. No.: 19/632,277

(22) Filed: Mar. 28, 2026

(30) Foreign Application Priority Data
Mar. 31, 2025 (FR) 2503308

(51) Int. Cl. G08G 5/72

(52) U.S. Cl. CPC G08G 5/72

(57) ABSTRACT

Tracking aircraft in an airspace, including acquiring plots representing a position of an aircraft, associating each plot with a respective initial subspace, each initial subspace including an initial track, which is a set of instantaneous positions of the aircraft, for each initial subspace, merging each plot associated with the initial subspace with an initial track of the initial subspace, providing an updated track, and redefining the initial subspaces as a function of the updated tracks, providing updated air subspaces, the updated tracks making it possible to characterize a trajectory of the aircraft and the updated tracks as well as the updated air subspaces making a new iteration of the tracking method possible.

### CROSS-REFERENCE TO RELATED APPLICATION

This application is a U.S. non-provisional application claiming the benefit of French Application No. 25 03308, filed on Mar 31, 2025, which is incorporated herein by reference in its entirety.

### TECHNICAL FIELD OF THE INVENTION

The present invention relates to a method for tracking aircraft in an airspace. It also relates to an associated computer program and set of servers.

### BACKGROUND OF THE INVENTION

The invention lies in the field of air traffic control and drone monitoring systems.

This field aims to implement a tracking system intended to calculate the best possible estimate of the position, heading and speed of each aircraft in a predefined region, based on data from sensors. This estimated data forms tracks, and this process of tracking is carried out by software.

To obtain these tracks, there are known techniques of dividing the predefined region into geographical subspaces, assigning the calculation of tracks on each subspace to a distinct physical module, and managing the interoperability between the subspaces by using track correlation modules. The function of the correlation modules is to merge identical tracks determined by multiple physical modules in boundary areas, which are the areas overlapping from one subspace to another.

On the one hand, such techniques are costly in terms of calculation, because certain tracks are calculated multiple times in the overlap areas between multiple subspaces, and because an additional correlation module with adjacent subspaces is used in order to amalgamate a single tracking situation.

On the other hand, these techniques are costly in terms of physical resources because they monopolize computing power per subspace regardless of the traffic level.

### SUMMARY OF THE INVENTION

There is therefore a need for a method for tracking aircraft that makes it possible to optimize the use of the hardware and software resources.

To this end, the description relates to a method for tracking aircraft in an airspace, including:

an operation of acquiring plots, with each plot representing an instantaneous position of an aircraft;

an operation of associating each plot with a respective initial subspace of the airspace, each initial subspace being a set of positions of the airspace and including at least one initial track, an initial track being a set of instantaneous positions of the aircraft, a track belonging to a subspace if its most recent instantaneous position belongs to the subspace;

for each initial subspace, an operation of merging each plot associated with the initial subspace with an initial track belonging to the initial subspace, providing an updated track; and

an operation of redefining the initial subspaces as a function of the updated tracks, providing updated air subspaces;

the updated tracks making it possible to characterize an aircraft trajectory and the updated tracks as well as the updated air subspaces, making it possible to make a new iteration of the tracking method.

By means of this tracking method, the air subspaces are dynamically redefined as a function of the evolution of traffic at each iteration of the tracking method.

In particular, the air subspaces are optimized to make parallel calculations between multiple modules possible, without introducing redundancy into the calculations.

Furthermore, since the air subspaces are limited to the areas effectively including tracks, the airspace covered by the method may be much larger than the control areas covered by existing solutions, which meets the tracking needs of growing air traffic.

According to other advantageous aspects, the tracking method includes one or more of the following features, taken alone or in any technically possible combinations:

the operation of redefining the initial air subspaces includes an update of each initial air subspace including an updated track, so that the updated air subspace contains the updated track;

the operation of redefining the initial air subspaces includes a separation of an initial air subspace into two distinct updated air subspaces, the separation being implemented when a separation criterion is satisfied;

the separation criterion is that the smallest distance between two updated tracks belonging to the same initial air subspace is greater than a predetermined maximum threshold, each of the two updated tracks then belonging to one or other of the distinct, updated air subspaces, respectively;

the operation of redefining the initial air subspaces includes uniting two initial air subspaces into a single updated air subspace, the uniting being implemented when a criterion for uniting is satisfied; the criterion for uniting is that the smallest distance between two initial air subspaces is less than a predetermined outer margin;

each air subspace is the smallest disk containing the set of tracks belonging to the air subspace;

each air subspace is the smallest disk containing the set of tracks belonging to the air subspace and a predetermined inner margin around each of the tracks;

each air subspace is the smallest polygon containing the set of tracks belonging to the air subspace;

each air subspace is the smallest set, called a graph, containing the set of tracks belonging to the air subspace;

the method includes a load balancing operation, the load balancing operation including assigning each operation of the method to an execution server of a set of execution servers as a function of the load of each execution server;

the associating operation is carried out by using a database of air subspaces, a plot being associated to an initial air subspace when the position represented by the plot belongs to an air subspace of the database of air subspaces;and

the merging operation is carried out by using a database of associations between tracks and air subspaces, a merging being carried out in accordance with the coherence of a plot with a track belonging to the initial associated air subspace.

The description also relates to a computer program including software instructions that implement a tracking method as defined above when executed by a computer.

The description also relates to a set of servers, including:

a master server, configured to implement the load balancing operation of a tracking method, as previously described; and

at least one execution server, configured to implement at least one operation of the tracking method assigned by the master server.

### BRIEF DESCRIPTION OF THE DRAWINGS

The invention will appear more clearly upon reading the description that follows, given solely by way of non-limiting example, and made with reference to the drawings, wherein:

FIG. 1 is a diagram of an example of a set of servers;

FIG. 2 is a flowchart of an example of implementation of a tracking method;

FIG. 3 is a diagram of three types of air subspaces used in the method of FIG. 2; and

FIG. 4 is a diagram representing different operations of redefining air subspaces according to the method of FIG. 2.

### DETAILED DESCRIPTION OF THE PREFERRED EMBODIMENTS

An airspace in which aircraft move is considered.

The aircraft are airliners or drones, for example.

Each aircraft is equipped with at least one sensor that provides data representing the position of the aircraft, called plot P.

By way of example, the sensor is a GPS (Global Positioning System) sensor, and the position data is a GPS coordinate.

In other words, each plot P represents an instantaneous position of the aircraft.

As such, each plot P may include one or more items of data, measured relative to this instantaneous position.

By way of illustration, it may also be envisaged that a plot P includes information on distance to multiple reference points, in particular to predefined beacons.

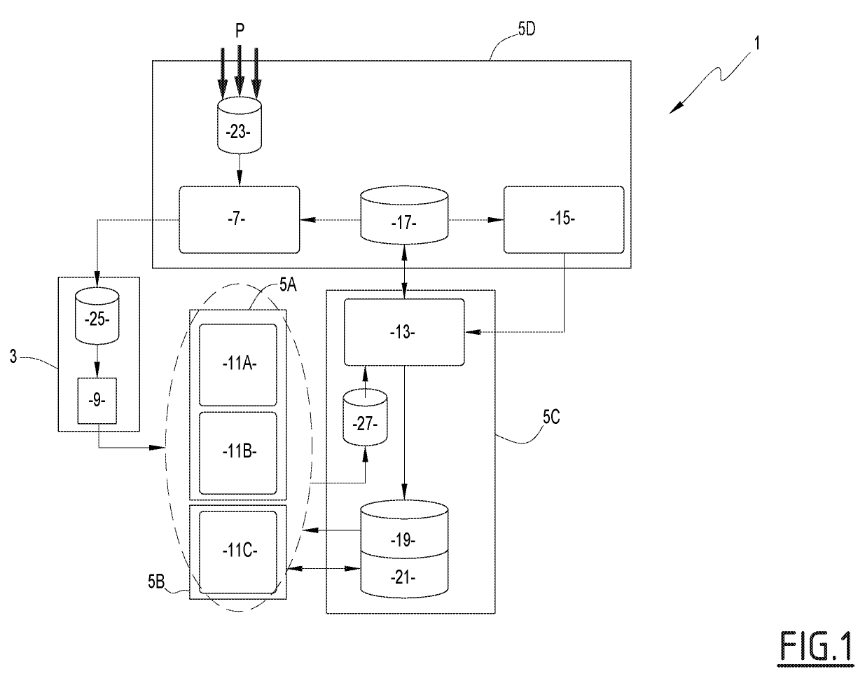

Plots P are transmitted by each aircraft to a set of servers 1, shown in FIG. 1, by radio, for example.

Set of servers 1 has the function of carrying out the tracking of the aircraft in the airspace, i.e., determining, from received plots P, a track associated with each aircraft in the airspace.

A track is a set of instantaneous positions of an aircraft.

To do so, according to the example described, set of servers 1 merges each incoming plot P into an existing track or into a new track.

In other words, set of servers 1 is configured to execute a tracking method, which will be described below.

Set of servers 1 is composed of a master server 3 and at least one execution server 5A, 5B, 5C and/or 5D.

Each server 3, 5A, 5B, 5C and 5D advantageously includes a processor, configured to execute at least one functional module of a set of functional modules, and a memory, configured to store a database among a set of databases.

Advantageously, a functional module is software, or a software brick, executable on the processor of one of servers 3, 5A, 5B, 5C or 5D.

Each functional module is also capable of being recorded on a computer-readable medium, not shown.

The computer-readable medium is a medium capable of storing electronic instructions and of being coupled to a computer system bus, for example. By way of example, the readable medium is an optical disk, a magneto-optical disk, a ROM memory, a RAM memory, any type of non-volatile memory (such as EPROM, EEPROM, FLASH, NVRAM), a magnetic card or an optical card. A computer program including software instructions is then stored on the readable medium.

According to the illustrated example, the set of functional modules advantageously includes an association module 7, a distribution module 9, at least one merge module 11A, 11B and/or 11C, a redefinition module 13, and a detection module 15.

The function of each functional module is described below.

Association module 7 is executed on server 5D in the example of FIG. 1.

Association module 7 is suitable for acquiring a set of plots P and for associating each plot P with a subspace, as explained later.

Distribution module 9 is executed on master server 3 and is configured to implement a load balancing operation 106. In other words, master server 3 is configured to distribute the execution of each module of the set of functional modules, apart from the distribution module, between servers 3, 5A, 5B, 5C and 5D and itself.

The set of databases advantageously includes a subspace database 17, a track database 19, and a track/subspace association database 21.

In a variant, not shown, the subspaces, the tracks and the track/subspace associations are stored in one and the same database.

Likewise for the functional modules: distribution module 9 of master server 3 is configured to distribute storage of each database of the set of databases among servers 3, 5A, 5B, 5C and 5D, and, more specifically, among their respective memories.

The distribution makes it possible to adapt use of the available hardware and software resources to the demand.

Furthermore, storing the databases on servers potentially different from the servers executing the functional modules makes it possible to limit a potential loss of data as well as provide greater modularity in the architecture.

In a variant, not shown, the tracking method is executed by one or more programmable logic component(s), such as an FPGA (Field Programmable Gate Array, often translated as in situ programmable gate array), or even in the form of one or more dedicated integrated circuit(s), such as an ASIC (Application Specific Integrated Circuit).

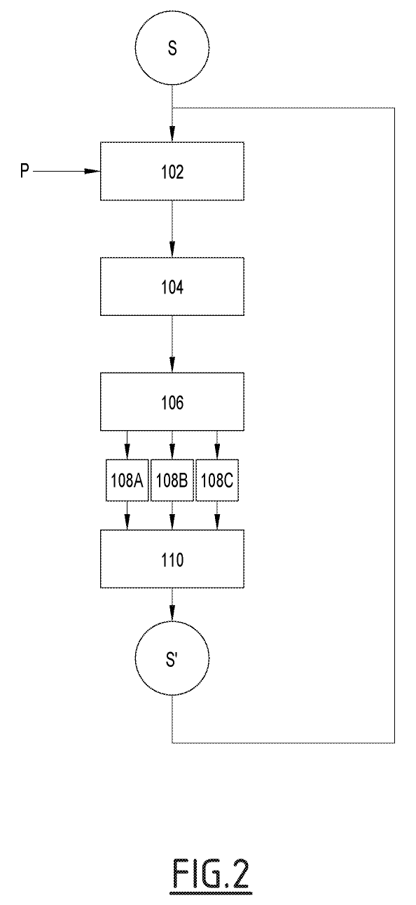

The tracking method implemented by set of servers 1 is described below with reference to the flowchart of FIG. 2.

The tracking method includes a plot acquisition operation 102, an association operation 104, at least one merge operation 108A, 108B and/or 108C and a redefinition operation 110, these operations being implemented in addition to the aforementioned load balancing operation 106.

Operations of acquisition 102 and association 104 are implemented by association module 7.

During acquisition operation 102, association module 7 acquires a set 23 of plots P, i.e., a variable containing multiple plots P.

Such a set 23 is sometimes referred to by the term “buffer” in reference to the fact that this set is stored in a predefined area of the memory. This term is used below to clarify the subject and to avoid any confusion with other sets.

Association module 7 thus acquires a buffer 23 of plots P.

This acquiring of buffer 23 is done progressively, upon receipt of each plot P, until a condition is met.

This condition may be the receipt of a predetermined number of plots P or the elapsing of a predefined time interval.

Association module 7 then has a complete buffer 23, and implements association operation 104.

During this operation, from buffer 23 of plots P and from reading subspace database 17, association module 7 associates each plot P with an initial subspace S of subspace database 17.

A subspace S is a set of airspace positions. Each initial subspace S includes at least one initial track, where a track is a set of instantaneous positions of an aircraft.

By definition, a track belongs to a subspace if its most recent instantaneous position belongs to the subspace.

More specifically, a track belongs to a subspace at a given moment if the most recent instantaneous position (i.e., the position closest to the given moment) of the instantaneous positions of the track concerned belongs to the subspace.

This most recent instantaneous position is denoted P’ below.

For each plot P, if the position represented by plot P belongs to an initial subspace S of subspace database 17, then plot P is associated with initial subspace S. Otherwise, plot P is associated with a subspace not existing in subspace database 17, called an unconfirmed subspace.

The association of each plot P with an initial subspace S is stored in a plot/subspace association buffer 25, which is transmitted to distribution module 9.

Upon receipt of buffer 25, distribution module 9 implements a load balancing operation 106.

Load balancing operation 106 includes assigning each operation of the method to one of execution servers 5A, 5B, 5C and 5D.

In particular, load balancing operation 106 includes distributing each merge operation 108A, 108B and 108C to one of execution servers 5A, 5B, 5C and 5D as a function of the resources required for each merge operation 108A, 108B and 108C and the resources available on each execution server 5A, 5B, 5C and 5D.

As explained previously, “distribution of operations” is understood here as a distribution of implementation of the operations, i.e., assigning of an operation to an execution server 5A, 5B, 5C or 5D results in the implementation of this operation by execution server 5A, 5B, 5C or 5D.

Each merge operation 108A, 108B and 108C is implemented by a respective merge module 11A, 11B and 11C.

In the example of FIG. 1, merge operations 108A and 108B are assigned to execution server 5A and merge operation 108C to execution server 5B.

In other words, merge modules 11A and 11B are executed on execution server 5A, and the merge module 11C is executed on execution server 5B.

The method includes as many merge operations 108A, 108B and 108C as there are initial subspace(s) S in plot/subspace association buffer 25.

In other words, each merge operation 108A, 108B and 108C corresponds to an initial subspace S of plot/subspace association buffer 25.

For each initial subspace S of buffer 25, the associated merge operation 108A, 108B or 108C includes merging each plot P associated with initial subspace S with an initial track belonging to initial subspace S, providing an updated track.

Merging a plot P with an initial track consists of adding the position associated with plot P to the initial track. Thus, each updated track includes one more position than the initial track from which it is derived.

To perform this operation, merge module 11A, 11B or 11C reads and writes in track database 19 and track/subspace association database 21.

Merging is performed by means of a known merge algorithm.

In particular, if a given plot P is inconsistent with any track belonging to the associated initial subspace S, or if the associated initial subspace S is an unconfirmed subspace, then the merge algorithm determines whether plot P corresponds to a new track or to an error. If plot P corresponds to a new track, the new track, including a single position corresponding to plot P, is added to track database 19. For a given track, position P’ corresponds to the last plot P merged with the track.

The updated tracks, stored in track database 19 at the end of merge operations 108A, 108B and 108C, make it possible to track a position, a heading and a speed of each aircraft moving in the airspace, in real time.

Redefinition operation 110 is implemented by merge modules 11A, 11B and 11C, detection module 15, and redefinition module 13.

Redefinition operation 110 includes redefining initial subspaces S as a function of the updated tracks, leading to obtaining updated air subspaces S’.

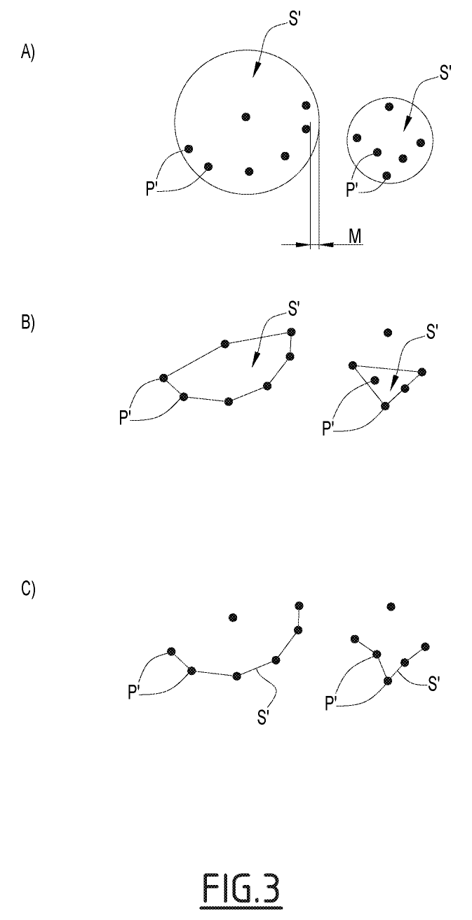

Multiple shapes are possible for updated subspaces S’, as illustrated in FIG. 3.

In each insert A, B and C, each corresponding to a different example, positions P’ are represented by points and the boundaries of updated subspaces S’ are represented by lines.

In the example shown in insert A of FIG. 3, each air subspace S’ is the smallest disk containing the set of tracks belonging to air subspace S’ and a predetermined inner margin M around each of the tracks. In other words, each air subspace S’ is the smallest disk containing the most recent position P’ of each of the tracks belonging to air subspace S’ and a predetermined inner margin M around each of positions P’.

In a variant, not shown, each air subspace is the smallest disk containing the most recent position P’ of each of the tracks belonging to air subspace S’, without inner margin M.

In the example shown in insert B of FIG. 3, each air subspace S’ is the smallest convex polygon containing the set of tracks belonging to air subspace S’. In other words, each air subspace S’ is the smallest convex polygon containing the most recent position P’ of each of the tracks belonging to air subspace S’.

In the example shown in insert C of FIG. 3, each air subspace S’ is the smallest set, called a graph, containing the set of tracks belonging to air subspace S’. In other words, each air subspace S’ is the smallest set containing the most recent position P’ of each of the tracks belonging to air subspace S’.

Applicant’s experiments have shown that the shape that makes the best compromise possible, in terms of calculational complexity and representing the tracking, is the convex polygon shape.

Whatever the shape retained, redefinition operation 110 of each initial subspace S as a function of the updated tracks advantageously includes an operation of updating O1 initial air subspaces S, an operation of separating O2 initial air subspaces S, and an operation of uniting O3 initial air subspaces S.

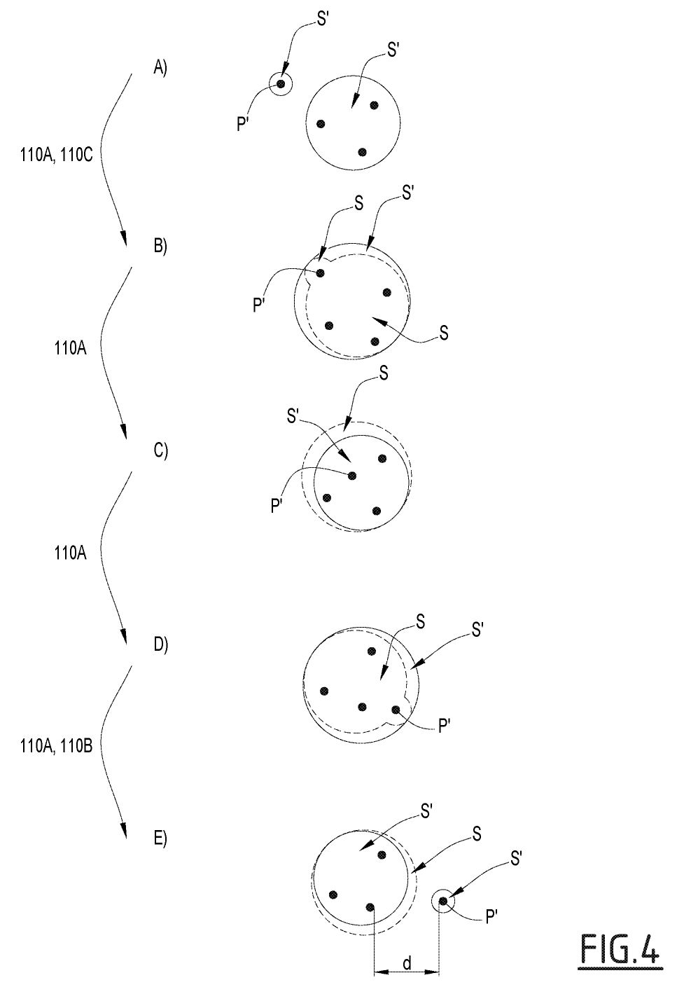

FIG. 4 illustrates evolution of air subspaces S over time, according to the first example of air subspace shapes S.

In FIG. 4, the dotted lines represent boundaries of initial subspace(s) S, while the solid lines represent boundaries of updated subspace(s) S’. Each insert corresponds to one iteration of the method, for example. For clarity, only one position P’ varies from one insert to another, the other positions being fixed.

Update operation O1 consists in updating each initial air subspace S including an updated track, so that updated air subspace S’ contains the updated track.

During transition from the moment shown in insert B to the moment shown in insert C of FIG. 2, variable position P’ has moved closer to the other positions.

Thus, in insert C, the smallest disk S’ containing the most recent position of each of the updated tracks is smaller than the smallest disk S containing the most recent position of each of the initial tracks.

Conversely, during transition from the moment shown in insert C to the moment shown in insert D of FIG. 2, variable position P’ has moved away from the other positions, so that smallest disk S’ containing the most recent position of each of the updated tracks is larger than smallest disk S containing the most recent position of each of the initial tracks.

It is then understood that update operation O1 makes it possible for updated subspaces S’ to always contain the last position P’ of each track that it contains, as well as inner margin M in the illustrated example.

In the exemplary architecture shown in FIG. 1, updated subspaces S’ are transmitted by merge modules 11A, 11B and 11C to redefinition module 13 via a redefinition buffer 27.

Upon receipt of redefinition buffer 27, redefinition module 13 modifies subspace database 17 accordingly.

In a variant, not shown, merge modules 11A, 11B and 11C directly modify subspace database 17.

In a variant, not shown, redefinition module 13 itself determines update operations O1 to be carried out from track database 19 and from track/subspace association database 21 updated by merge modules 11A, 11B and 11C.

Separation operation O2 consists in separation of an initial air subspace S into two distinct updated air subspaces S’.

This separation occurs when a separation criterion is met.

According to one particular example of a separation criterion, the separation is implemented when the smallest distance d between two updated tracks belonging to the same initial air subspace S is greater than a predetermined maximum threshold, each of the two updated tracks then respectively belonging to one or the other of the distinct updated air subspaces S’.

The smallest distance between two tracks is defined as the distance separating the last position P’ of each of the two respective tracks.

Separation operation O2 occurs between the moments corresponding to inserts D and E of FIG. 4. With distance d between position P’ and the other position closest to P’ belonging to initial subspace S being greater than the threshold, initial subspace S is separated into two updated subspaces S’.

It is then understood that separation operation O2 makes it possible to reduce the number of tracks in each updated subspace S’.

Reducing the number of tracks per updated subspace S’ makes it possible to better distribute the load among the different execution servers 5A, 5B, 5C and 5D.

Furthermore, the separation criterion based on distance d makes it possible to keep close tracks in the same updated subspace S’, which makes it possible to process merging these tracks together and to limit the effects of existing boundaries in the current solutions.

In the architectural example shown in FIG. 1, separation operations O2 are detected by merge modules 11A, 11B and 11C, and then transmitted to redefinition module 13 via redefinition buffer 27.

Upon receipt of redefinition buffer 27, redefinition module 13 modifies subspace database 17 accordingly.

In a variant, not shown, merge modules 11A, 11B and 11C directly modify subspace database 17.

In a variant, not shown, redefinition module 13 itself determines the selection operation O2 to be carried out from track database 19 and track/subspace association database 21 updated by merge modules 11A, 11B and 11C.

Uniting operation O3 consists in merging two initial air subspaces S into a single updated air subspace S’, the merging being implemented when a condition for uniting is satisfied.

An example of a condition for merging is that the smallest distance between two initial air subspaces is less than a predetermined outer margin.

In a variant, when the definition of subspaces S includes an inner margin M, the condition for uniting is that the boundaries of two initial subspaces S overlap. This is equivalent to setting the outer margin to 0.

Uniting operation O3 according to this variant is shown in insert B of FIG. 4. With the two initial subspaces S overlapping, they are brought together so as to define a single air subspace S’, which, in the example, is the smallest disk containing the most recent position P’ of each of the tracks of the two initial subspaces S.

It is then understood that uniting operation O3 makes it possible to process all tracks that are close to one another, the “closeness” being determined by the predetermined outer margin or by inner margin M when defining the subspaces S.

By way of example, the predetermined outer margin or inner margin M is equal to 4 nautical miles.

Thus, uniting operation O3 makes it possible to limit the existing boundary effects in the current solutions.

In the architecture example shown in FIG. 1, detection module 15 is dedicated to detecting uniting of subspaces S. Modification of subspace database 17 is then carried out by redefinition module 13 accordingly. In a variant, not shown, detection module 15 directly modifies subspace database 17.

In a variant, not shown, redefinition module 13 itself determines the uniting operations O3 to be performed.

According to another variant, not shown, detection module 15 is further configured to detect separation operations O2.

At the end of redefinition operation 110, the method provides a set of updated air subspaces S’, making a new iteration of the method with new plots P possible while optimizing hardware and software resources of set of servers 1 as much as possible.

To ensure proper operation of the method, it is advantageous that at least one operating server 5A, 5B, 5C or 5D is capable of implementing each merge operation 108A, 108B and 108C.

In other words, each subspace S must contain a sufficiently low number of tracks, i.e., less than an upper limit, to be able to be processed by the same merge module 11A, 11B or 11C. The upper limit is determined by the computing capacity of the servers.

Simulations have shown that, taking the subspaces S in the form of a graph, the maximum number of tracks reached in a subspace S remains 3 times lower than the upper limit, when air traffic is multiplied by 10 compared with current air traffic.

In a variant, not shown, a monitoring module is dedicated to checking the number of tracks per subspace S. If a uniting operation O3 causes the number of tracks in a subspace S to exceed the upper limit, then merge operation 108C is not carried out.

Preferably, a uniting operation O3 is implemented only if the number of tracks in the resulting set is below the limit. In this way, the merge operations may continue to update tracks of their respective subspaces; only the overlap area of the two subspaces is degraded. This is preferable to having a subspace that is too large and having to abandon merging of all the tracks of that subspace.

It may be noted here that the tracking method is also usable in a non-interactive context, i.e., when the aircraft is not equipped with a transponder or when the transponder is not active. Such a type of non-interactive target is detected by primary radars, by emitting waves and detecting their reflection from the target, for example.

Any feature described above for an example or a variant may also be implemented for the other examples and variants described above, insofar as technically possible.

1. A method for tracking aircraft in an airspace, comprising:
acquiring plots, each plot representing an instantaneous position of an aircraft;
associating each plot with a respective initial air subspace of the airspace, each initial air subspace being a set of positions of the airspace and comprising at least one initial track, an initial track being a set of instantaneous positions of the aircraft, a track belonging to an air subspace if its most recent instantaneous position belongs to the air subspace;
for each initial air subspace, merging each plot associated with the air initial subspace with an initial track belonging to the initial air subspace, providing an updated track; and
redefining the initial air subspaces as a function of the updated tracks, providing updated air subspaces,
the updated tracks making it possible to characterize a trajectory of the aircraft, and the updated tracks as well as the updated air subspaces enabling a new iteration of the tracking method.

2. The method according to claim 1, wherein said redefining comprises updating each initial air subspace comprising an updated track so that the updated air subspace contains the updated track.

3. The method according to claim 1, wherein said redefining comprises separating an initial air subspace into two distinct updated air subspaces, the separation being implemented when a separation criterion is met.

4. The method according to claim 3, wherein the separation criterion is that a smallest distance between two updated tracks belonging to the same initial air subspace is greater than a predetermined maximum threshold, each of the two updated tracks then respectively belonging to one or the other of the two distinct updated air subspaces.

5. The method according to claim 1, wherein said redefining comprises uniting two initial air subspaces into a single updated air subspace, the uniting being implemented when a criterion for uniting is met.

6. The method according to claim 5, wherein the criterion for uniting is that a smallest distance between two initial air subspaces is less than a predetermined outer margin.

7. The method according to claim 1, wherein each air subspace comprises a smallest disk containing the tracks belonging to the air subspace.

8. The method according to claim 1, wherein each air subspace comprises a smallest disk containing the tracks belonging to the air subspace and a predetermined inner margin around each of the tracks.

9. The method according to claim 1, wherein each air subspace comprises a smallest polygon containing the tracks belonging to the air subspace.

10. The method according to claim 1, wherein each air subspace comprises a smallest set containing the tracks belonging to the air subspace.

11. The method according to claim 1, further comprising load balancing comprising assigning each operation of the method to one execution server of a set of execution servers as a function of the load of each execution server.

12. A non-transient computer-readable memory storing software instructions which, when implemented by a computer, cause the computer to implement a method according to claim 1.

13. A set of servers, comprising:
a master server, configured to implement the load balancing operation of a tracking method according to claim 11; and
at least one execution server, configured to implement at least one operation of the tracking method assigned by the master server.
